(19) United States
(12) Patent Application Publication
(10) Pub. No.: US 2026/0121452 A1
(43) Pub. Date: Apr. 30, 2026

(54) WIRELESS CHARGING AND SIGNAL TRANSMISSION DEVICE FOR A DEEP-SEA UUV DOCKING SYSTEM

(71) Applicant: ZHEJIANG UNIVERSITY, Hangzhou (CN)

(72) Inventors: MINGWEI LIN, HANGZHOU (CN); SHUO GONG, HANGZHOU (CN); RI RI, HANGZHOU (CN); DEJUN LI, HANGZHOU (CN); CANJUN YANG, HANGZHOU (CN)

(21) Appl. No.: 19/364,905

(22) Filed: Oct. 21, 2025

(30) Foreign Application Priority Data
Oct. 24, 2024 (CN) 202411491856.3

(51) Int. Cl. H02J 50/00; H01F 41/06; H02J 50/12; H02J 50/90

(52) U.S. Cl. CPC H02J 50/005; H01F 41/06; H02J 50/12; H02J 50/90

(57) ABSTRACT

A wireless charging and signal transmission device for a deep-sea UUV docking system, includes a transmitting end installed on a docking platform and a receiving end installed on a deep-sea UUV. The transmitting end and the receiving end respectively include: an integrated coil/antenna mount, a bottom is connected to an adapter end cover, and a top is provided with three grooves, wherein an antenna, a magnetic core and a coil are installed in the first, second and third grooves, respectively; a non-metallic sealing cover covers the top of the integrated coil/antenna mount; the adapter end cover connected to the coil/antenna through the watertight cable; a power and signal output/receiving circuit is installed in a cavity; a bottom end cover installed with a composite watertight connector to connect to the UUV or the docking platform; and the transmitting end includes a flexible guide cylinder fixed on the integrated coil/antenna mount.

### TECHNICAL FIELD

The present invention relates to the technical field of underwater wireless charging, and in particular to a wireless charging and signal transmission device for a deep-sea UUV docking system.

### BACKGROUND TECHNOLOGY

An unmanned underwater vehicle (UUV) is a mobile ocean observation platform capable of carrying various sensors to perform observation and detection tasks. However, UUVs are typically powered by batteries, which have limited energy capacity and cannot stay and operate underwater for a long time. Therefore, scientists have proposed use of subsea docking base stations or docking platforms to autonomously recover the UUVs and replenish their power supply. An underwater wireless charging technology is currently a popular research direction for UUV underwater charging, and various research institutes both domestically and internationally have proposed different types of underwater wireless charging/signal transmission devices for the UUVs.

For example, a Chinese patent with publication No. CN 116714453 A discloses a UUV underwater charging device and charging method. The charging device comprises a device housing, within which a central module is arranged. Several sub-modules are led out from the central module. The central module is provided with a fuel cell, which is connected to an inverter and a central management module. A communication and positioning module is connected to the central management module. Each sub-module is provided with a sub-management module, which is connected to the central management module. A wireless charging module and a guide light are connected to the sub-management module, wherein the wireless charging module is connected to the inverter of the central module and is uniformly distributed on an inner layer of the device housing, for connecting to and charging an external UUV to be charged. A Chinese patent with publication No. CN 116039412 A discloses a wireless charging and communication modular compartment for small UUVs, comprising: a secondary component, a pressure-resistant housing, a network connector, a controller area network (CAN) connector, a power connector, and a charging and communication module. The modular compartment achieves neutral buoyancy in water. The secondary component is used to sense magnetic field changes of an external primary coil to generate current. The pressure-resistant housing has a cylindrical cavity structure, with a groove designed on one radial side to accommodate the secondary component and ensure that the secondary component conforms to an outer surface of the pressure-resistant housing. One end of the network connector, the CAN connector, and the power connector are all connected to the charging and communication module, and the other ends thereof are respectively connected to a network switch, a CAN bus data link, and a battery on the UUV. The secondary component and the charging and communication module are connected via an electrical connection cable.

Currently, the underwater wireless charging/signal transmission devices can be divided into two categories. One category involves a coil/antenna with independent encapsulation, which are then connected to the circuit cavity via watertight connectors. The other category involves integrating the coil/antenna with and an end cap of the circuit cavity by means such as potting or vulcanization, after which a wire/signaling wire of the coil/antenna is directly extended into the cavity. However, the former suffers from a large volume and lack of compactness, while the latter, if leakage occurs, allows water to directly enter the circuit cavity, resulting in serious consequences.

In addition, for deep-sea applications, regardless of the above methods, a comprehensive design of sealing and pressure resistance remains a major challenge. If a potting-type sealing scheme is adopted, stress concentration and leakage may occur in the antenna and coil after micro-deformation of a potting material, which can easily damage the coil or antenna. If an oil-filled sealing method is used, the device is in an internal-external pressure-balanced state, and the antenna and coil directly bear a high pressure, which many components cannot withstand. If an external housing is directly used for pressure resistance, encapsulation becomes excessively large and heavy, and the metal housing hinders magnetic field penetration and severely reduces power transfer and communication efficiency, which is not conducive to integration of a UUV docking system.

Based on the above background analysis, it is evident that there is an urgent need for a coil/antenna integrated encapsulation method that features reliable sealing, adaptability to deep-sea high-pressure environments, and a compact size, so as to lay a foundation for the UUV underwater wireless charging/signal transmission technology in the deep-sea environments.

### SUMMARY OF THE INVENTION

The present invention provides a wireless charging and signal transmission device for a deep-sea UUV docking system, which is compact in size, lightweight, reliably sealed, and capable of reliable operation in deep-sea environments for a lone time.

The technical schemes of the present invention are as follows:

A wireless charging and signal transmission device for a deep-sea UUV docking system, comprising a transmitting end installed on a docking platform and a receiving end installed on a deep-sea UUV;
the transmitting end and the receiving end, respectively, comprise:
an integrated coil/antenna mount, a bottom of which is connected to an adapter end cover, and a top of which is provided with a first groove, a second groove surrounding the first groove, and a third groove surrounding the second groove, wherein an antenna is installed in the first groove, a magnetic core is installed in the second groove, a coil is installed in the third groove, and bottoms of the first groove and the third groove are provided with through holes, which are respectively used for installing watertight seats of watertight cables connecting an antenna and the coil; the first groove, the second groove and the third groove are uniformly potted with epoxy resin; and an outer periphery of the third groove is provided with an O-ring;
a non-metallic sealing cover, which covers the top of the integrated coil/antenna mount;
the adapter end cover, which is connected to the coil/antenna through the watertight cable;
a cavity, inside which a power and signal output circuit is installed, or inside which a power and signal receiving circuit is installed;
a bottom end cover, which is installed with a composite watertight connector for signal and power, which is used to connect to the UUV or the docking platform; and

the transmitting end further comprises a flexible guide cylinder for guiding the receiving end to dock and align with the transmitting end, and the flexible guide cylinder is fixed on the integrated coil/antenna mount of the transmitting end.

Preferably, a support cylinder for constraining the watertight cable is further provided between the integrated coil/antenna mount and the adapter end cover; and the support cylinder is composed of at least two arcuate plates.

Installation of a semi-circular support cylinder shall be carried out before installation of the flexible guide cylinder. The method is as follows: screws arranged in a circular array pass through the integrated coil/antenna mount and the through holes arranged on circumference of the semi-circular support cylinder in sequence, and finally connect with threaded holes on the adapter end cover. Before installing the semi-circular support cylinder, it is necessary to connect the integrated coil/antenna mount with the watertight seat on the adapter end cover via the watertight cable. Then, the cable is constrained inside the support cylinder to improve space utilization of a connector.

Preferably, a top housing thickness of the non-metallic sealing cover is 0.5 mm to 1 mm; and a side wall thickness is not less than 5 mm. The top housing is relatively thin, which ensures a sufficiently short distance between the coils/antennas of the transmitting end and the receiving end, thereby improving transmission efficiency.

Preferably, a material of the non-metallic sealing cover is polyether ether ketone (PEEK).

The cavity of the transmitting end is equipped with an inverter, a primary resonant network circuit, a high/low voltage conversion circuit, and a signal processing circuit; the cavity of the receiving end is internally installed with a signal transmission circuit, a secondary resonant network circuit, a high/low voltage conversion circuit, a rectifier, and a charging circuit.

The receiving end does not need to draw power from the battery of the UUV; instead, it utilizes the energy transmitted by the transmitting end through the coil for rectification and high-low voltage regulation, and then supplies power to the signal transmission circuit of the receiving end and an isolation chip in the charging circuit. This avoids a data interaction failure caused by a UUV battery connection fault.

Preferably, a port of the flexible guide cylinder is provided with a permanent magnet; and an outer wall of the integrated coil/antenna mount at the receiving end is provided with a flange, and the flange is provided with a stainless steel ring adapted to the permanent magnet.

The stainless steel ring of the receiving end can be magnetically locked with the permanent magnet on an end face of the flexible guiding tube of the transmitting end in any rotational direction.

An inner wall of one end of the flexible guide cylinder is of a cylindrical surface, the cylindrical surface has an annular boss, and the non-metallic sealing cover of the transmitting end contacts the annular boss; and the other end of the flexible guide cylinder is provided with a conical inclined surface for guiding the receiving end.

Under the guidance of the flexible guiding tube, the non-metallic sealing cover of the receiving end contacts the non-metallic sealing cover of the transmitting end along the conical inclined surface; if there is no significant docking misalignment, front end planes of the two non-metallic sealing covers are in close contact; and if there is docking misalignment (excessive UUV berthing position deviation), the deformation of the flexible guiding tube guides contact of the front ends of the two sealing covers, but they cannot be completely fitted. At this time, the permanent magnet and the stainless steel ring can still be magnetically attracted, overcoming interference from ocean currents and other factors.

The manufacturing method of the integrated coil/antenna mount comprises:
(1) winding an Litz wire into a cylindrical coil, winding the coil until the inductance value thereof reaches half of a desired value, insulating the coil, and then placing the coil into the third groove;
(2) putting a plurality of magnetic cores into the second groove; after covering with the non-metallic sealing cover, adjusting the size of the magnetic core and the number of coil turns according to whether mutual inductance between the two coils of the transmitting end and the receiving end meets requirements, until the mutual inductance of the two coils meets the requirements;
(3) installing a watertight connector at the bottom of the integrated mount, and welding inner wires of the watertight connector to the coil wires;
(4) applying vacuumed silica gel liquid on a surface of the coil with a thickness of 0.5 mm to 1 mm; applying the vacuumed silica gel liquid on an outer surface of a ceramic antenna with a thickness of 0.5 mm to 1 mm;
(5) connecting a feeder of the ceramic antenna to the watertight connector; and after the silica gel liquid dries, installing and fixing the ceramic antenna into the first groove;
(6) pouring vacuumed epoxy resin liquid into the first groove, the second groove, and the third groove, so that the epoxy resin liquid is slightly higher than the top of the integrated mount; and
(7) after the epoxy resin is cured, turning a protruding part of the epoxy resin until being flush with a top of an encapsulation member, then covering it with the non-metallic sealing cover and fixing it with a radial screw.

Thus, the integrated antenna/coil encapsulation structure is completed.

When the non-metallic sealing cover is subjected to an external high pressure, it undergoes slight deformation, radially approaching an outer circumference of the integrated mount and axially approaching a top end face of the epoxy resin. Through extrusion fit of the epoxy resin and a radial sealing O-ring, it is ensured that the deformation of the sealing cover under a high pressure is sufficiently small, and a resulting stress meets strength requirements, thereby achieving lightweight high-pressure sealing.

Compared with the prior art, the beneficial effects of the present invention are as follows:
(1) The coil and antenna integrated encapsulation technology of the present invention uses a non-metallic thin-housing sealing cover on one side to form an O-ring sealing structure for an internal epoxy resin potting body, while the internal epoxy resin also provides structural support for the sealing cover of the external thin-housing, preventing collapse under the high pressure, thereby endowing the encapsulation with high pressure resistance, compact size, reliable sealing, and leak-free advantages;
(2) The encapsulation method for the antenna, magnetic core, and coil of the present invention adopts soft rubber pretreatment, followed by environmental resin potting, which solves the problem of stress concentration and collapse of ceramic antennas and coil magnetic cores under high-pressure deformation; and
(3) The wireless energy and signal transmission device of the present invention is locked by plug-in via the flexible guiding tube, avoiding mechanical interference due to UUV docking deviation. In the event of plug-in position deviation, the magnetic core can also constrain the magnetic field of the coil to the outside of the antenna, ensuring a sufficient coupling coefficient in the case of coil misalignment, while suppressing interference caused by the magnetic field passing through the antenna, thereby overcoming the challenge of high docking accuracy requirements for the plug-in underwater wireless charging device for the UUV.

### BRIEF DESCRIPTION OF THE DRAWINGS

FIG. 1 is a schematic diagram of a UUV underwater wireless power/signal transmission device in use;

FIG. 2 is a schematic diagram of an external structure of the device;

FIG. 3 is a schematic diagram of integrated installation of a coil and antenna;

FIG. 4 is a side view of an integrated coil and antenna mount;

FIG. 5 is a sectional view of a flexible guiding tube; and

FIG. 6 is a schematic diagram of a circuit architecture of the wireless power/signal transmission device.

### DETAILED DESCRIPTION OF THE EMBODIMENTS

The present invention is described in further detail below in conjunction with the drawings and embodiments. It should be noted that the embodiments below are intended to facilitate the understanding of the present invention and do not have any limiting effect on it.

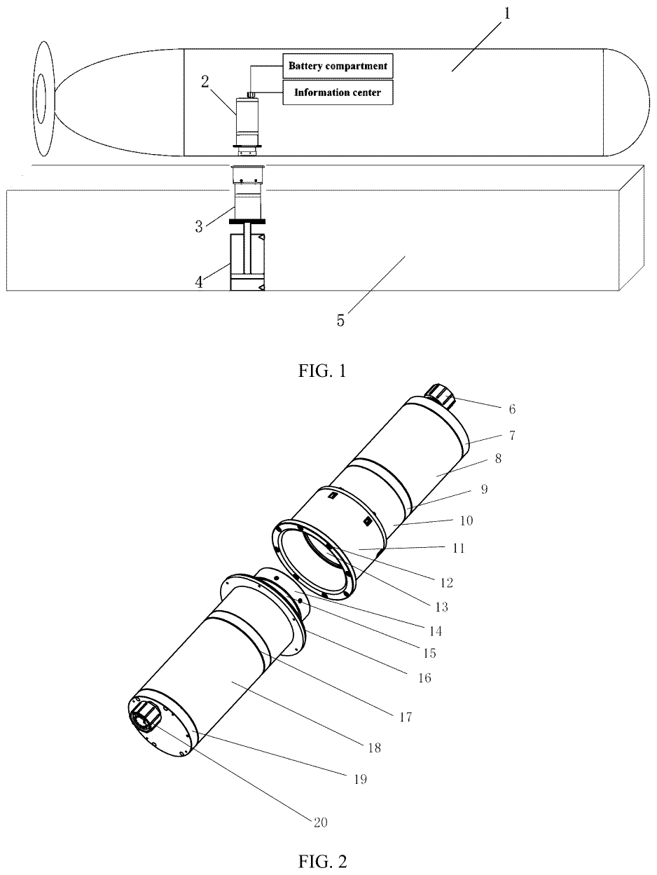

As shown in FIG. 1, a deep-sea UUV docking system consists of a UUV 1 and a docking platform 5. A wireless charging and signal transmission device of the UUV comprises a transmitting end 3 and a receiving end 2. The transmitting end is lifted and lowered by a hydraulic cylinder 4, thereby achieving a connection with the receiving end.

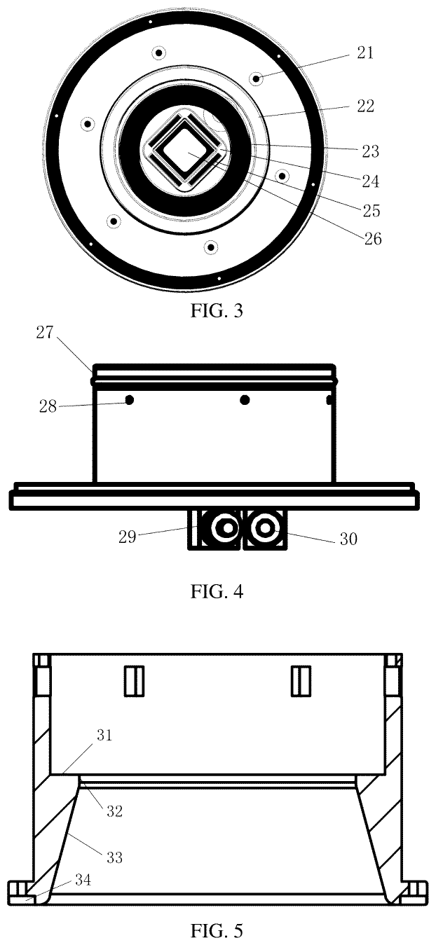

As shown in FIG. 2, the transmitting end of the device comprises:
a flexible guiding tube 11, which is made of a high-hardness silicone rubber material and used to guide the device to dock and align with the receiving end 2, while preventing an interference issue caused by UUV misalignment; and
a permanent magnet 12, which is fixed on an end face of the flexible guiding cylinder and is fastened with a countersunk screw, wherein the number of permanent magnets used is determined according to a plug-in force provided by the lifting hydraulic cylinder 4; and
a transmitting end integrated coil/antenna mount 16, which is present on both the transmitting end and the receiving end, wherein the bottom of the mount has a flange structure, with through holes for bolt fixation with the flexible guiding cylinder; and outer circumference is provided with threaded holes 28 for installation and fixation of a non-metallic sealing cover 14, wherein
as shown in FIG. 3 and FIG. 4, the top of the above integrated mount is provided with three grooves: a centrally located square-like groove is used for installing a ceramic antenna 26, with a through hole at a bottom of the groove for mounting a bent coaxial cable watertight seat 29; a thickness of the through hole is preferably 5 mm to 10 mm to ensure that the threads of the watertight seat can extend into the groove, thereby allowing adjustment of a bending direction of the watertight seat; and an outer annular groove 22 is used for installing the coil 23, with a through hole at a bottom for installing the bent two-core watertight seats 30, wherein a protruding structure 24 between the two grooves is provided with four circumferentially distributed grooves for installing a magnetic core 25, which increase self-inductance and mutual inductance of the coil, constrain a direction of a magnetic field, and prevent the magnetic field from passing through the central ceramic antenna 26, wherein the above three grooves are uniformly potted with epoxy resin;
a non-metallic sealing cover 14, which is positioned over the top of the transmitting end integrated antenna/coil mount 15, and secondary sealing of the potted coil/antenna integrated structure is achieved by means of an O-ring 27 on the outer circumference of the integrated mount, wherein a preferred thickness of a thin housing on a top surface of the sealing cover is 0.5 mm to 1 mm, and a radial thickness is not less than 5 mm, ensuring that a distance between the coils/antennas at the transmitting end and the receiving end is sufficiently short to improve transmission efficiency, wherein a preferred material for the sealing cover is a non-metallic material with high hardness and strength, such as PEEK;
semi-circular support cylinders 10 with two pieces per side, which are installed between the transmitting end adapter end cap and the transmitting end integrated coil/antenna mount, wherein installation of a semi-circular support cylinder 10 shall be carried out before installation of the flexible guide cylinder 11; the method is as follows: screws arranged in a circular array pass through the integrated coil/antenna mount and the through holes 21 arranged on circumference of the semi-circular support cylinder in sequence, and finally connect with threaded holes on the adapter end cover 9; and before installing the semi-circular support cylinder, it is necessary to connect the watertight seats on both sides, that is, connect the integrated coil/antenna mount with the watertight seat on the adapter end cover 9 via the watertight cable, and then, the cable is constrained inside the semi-circular support cylinder to improve space utilization of the connector.
a transmitting end adapter end cap 9, which is connected via a watertight cable and the coil/antenna, and transmits energy and signals within the cavity to the coil 23 and the antenna 26;
a transmitting end cavity 8, which is used to install an inverter (including a main circuit and a drive circuit), a primary resonant network circuit, a high/low voltage conversion circuit, and a signal processing circuit; and
a transmitting end bottom end cap 7, which is used for installing a signal-power composite watertight connector 6, and then connecting to the UUV docking platform 5. The UUV docking platform 5 supplies energy to the transmitting end and communicates with the transmitting end via a network.

The receiving end comprises: a non-metallic sealing cover, an integrated antenna/coil mount, a coil, an antenna, a magnetic core, a stainless steel ring, a semi-circular support cylinder, a watertight connector, a receiving end adapter end cap, a receiving end cavity, a receiving end bottom end cap, and a signal-power composite watertight connector.

Compared with the transmitting end 3, the external structure of the receiving end 2 differs in that it does not have the flexible guide cylinder 11 or the permanent magnet 12, but a stainless steel ring 16 is installed on the bottom flange of the integrated antenna/coil mount at the receiving end, enabling magnetic attraction and locking with the permanent magnet 12 on the end face of the transmitting end guide cylinder in any rotational direction.

The receiving end cavity is internally installed with a signal transmission circuit, a secondary resonant network, a high/low voltage conversion circuit, a rectifier, and charging circuit.

The above-mentioned charging circuit and signal transmission circuit are connected to the UUV via the signal-power composite watertight connector, thereby completing charging and signal transmission.

A manufacturing process flow for the integrated antenna/coil encapsulation structure is as follows:
step 1: using a Litz wire to wind a cylindrical coil, wherein selecting a cylindrical fixture and winding a first layer of coils on an outer surface of the cylinder; after each turn, infiltrating the wire with 502 glue and waiting for it to cure; then, covering the entire surface of this layer with insulating tape, ensuring that the insulating tape is not less than 5 mm higher or lower than the bottom of the coil to prevent cross breakdown; and repeating the above steps until an inductance value of the coil reaches half of an expected value;
step 2: removing the coil from the cylindrical fixture and completely wrapping its inner and outer surfaces with the insulating tape; next, placing the coil into the annular groove of the integrated antenna/coil encapsulation member, and placing a certain number of non-metallic annular gaskets at the bottom of the coil to raise a top height of the coil to 2 mm away from the top of the integrated encapsulation member, wherein the transmitting end coil and the receiving end coil are processed in the same manner as described above;
step 3: placing several magnetic cores in the four circumferentially distributed grooves in the middle of the integrated encapsulation member, with the top of the magnetic cores located 2 mm below the top of the grooves; bonding and fixing the magnetic cores in the grooves, and testing self-inductance of the coil; after the self-inductance of the coil meets the requirements, covering both sides of the encapsulation member with non-metallic sealing covers, aligning them, and then testing whether mutual inductance of the two coils meets the requirements; and continuously adjusting a size of the magnetic cores and the number of coil turns until the mutual inductance meets the requirements;
step 4: removing the non-metallic sealing covers on both sides, installing watertight connectors at the bottom of the integrated mounts on both sides, welding wires inside the connectors to the coil wires, and wrapping insulating tape around welded joints;
step 5: applying vacuumed silicone liquid to the surface of the coils, with a coating thickness of 0.5 mm to 1 mm;
step 6: similarly, applying vacuumed silicone liquid to an outer surface of the ceramic antenna, with an application thickness of 0.5 mm to 1 mm; connecting a feeder of the antenna to the watertight connector, and applying the silicone fluid to an SMA connector as well; and after the silicone fluid dries, installing the ceramic antenna at a distance of 1 mm to 2 mm from the top of the encapsulation member and fixing it in place;
step 7: pouring vacuumed epoxy resin liquid into all grooves, ensuring the liquid fills the grooves completely and slightly rises above the top of the integrated encapsulation member due to surface tension; and
step 8: after the epoxy resin has cured, utilizing a lathe to turn the protruding epoxy resin until being flush with a top of the encapsulation member; and afterwards, fitting the non-metallic sealing cover and securing it with radial screws.

Thus, the integrated antenna/coil encapsulation structure is completed.

When the non-metallic sealing cover is subjected to an external high pressure, it undergoes slight deformation, radially approaching an outer circumference of the integrated encapsulation member and axially approaching a top end face of the epoxy resin. Through turning of the epoxy resin and extrusion fit of the radial sealing O-ring, it is ensured that the deformation of the sealing cover under a high pressure is sufficiently small, and a resulting stress meets strength requirements, thereby achieving lightweight high-pressure sealing.

The method of using the flexible guide cylinder in the device is as follows:

As shown in FIG. 5, the transmitting end coil sealing cover is installed from a non-tapered side, and a front end of the sealing cover comes into contact with a bottom 31 of the cylindrical groove on the non-tapered side of the flexible guide cylinder. Under guidance of the flexible guide cylinder, the coil sealing cover of the receiving end contacts the coil sealing cover of the transmitting end along the conical inclined surface 33. If there is no significant docking misalignment, front end planes of the two non-metallic sealing covers are in close contact; and if there is docking misalignment (excessive UUV berthing position deviation), the deformation of the flexible guiding tube guides contact of the front ends of the two sealing covers, but they cannot be completely fitted. At this time, the permanent magnet installed in a hole 34 can still attract the stainless steel ring on the other side, which overcomes interference from ocean currents and other factors.

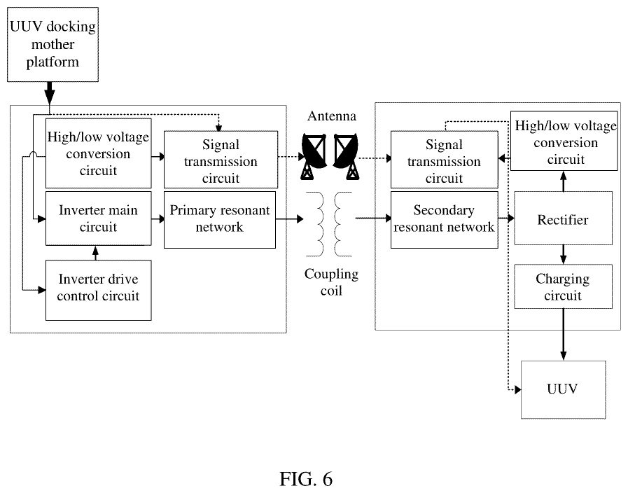

As shown in FIG. 6, a power flow method of the UUV docking system is as follows:

The receiving end does not need to draw power from the battery of the UUV. Instead, it utilizes the energy transmitted by the transmitting end through the coil for rectification and high-low voltage regulation, and then supplies power to the signal transmission circuit of the receiving end and an isolation chip in the charging circuit. This avoids a data interaction failure caused by a UUV battery connection fault.

The above embodiments describe in detail the technical schemes and beneficial effects of the present invention. It should be understood that the above embodiments are only specific embodiments of the present invention and are not used to limit the present invention. Any modification, supplement and equivalent replacement etc. made within the scope of the principle of the present invention shall be included within the protection scope of the present invention.

1. A wireless charging and signal transmission device for a deep-sea UUV docking system, the device comprising a transmitting end installed on a docking platform and a receiving end installed on the deep-sea UUV;
the transmitting end and the receiving end, respectively, comprise:
an integrated coil/antenna mount, a bottom of which is connected to an adapter end cover, and a top of which is provided with a first groove, a second groove surrounding the first groove, and a third groove surrounding the second groove, wherein an antenna is installed in the first groove, a magnetic core is installed in the second groove, a coil is installed in the third groove, and bottoms of the first groove and the third groove are provided with through holes, which are, respectively, used for installing watertight seats of watertight cables connecting an antenna and the coil; the first groove, the second groove and the third groove are uniformly potted with epoxy resin; and an outer periphery of the third groove is provided with an O-ring;
a non-metallic sealing cover, which covers the top of the integrated coil/antenna mount;
the adapter end cover, which is connected to the coil/antenna through the watertight cable;
a cavity, inside which a power and signal output circuit is installed, or inside which a power and signal receiving circuit is installed;
a bottom end cover, which is installed with a composite watertight connector for signal and power, which is used to connect to the UUV or the docking platform; and
the transmitting end further comprises a flexible guide cylinder for guiding the receiving end to dock and align with the transmitting end, and the flexible guide cylinder is fixed on the integrated coil/antenna mount of the transmitting end.

2. The wireless charging and signal transmission device for a deep-sea UUV docking system according to claim 1, wherein a support cylinder for constraining the watertight cable is further provided between the integrated coil/antenna mount and the adapter end cover; and the support cylinder is composed of at least two arcuate plates.

3. The wireless charging and signal transmission device for a deep-sea UUV docking system according to claim 1, wherein a top housing thickness of the non-metallic sealing cover is 0.5 mm to 1 mm; and a side wall thickness is not less than 5 mm.

4. The wireless charging and signal transmission device for a deep-sea UUV docking system according to claim 1, wherein a material of the non-metallic sealing cover is polyether ether ketone.

5. The wireless charging and signal transmission device for a deep-sea UUV docking system according to claim 1, wherein the cavity of the transmitting end is internally installed with an inverter, a primary resonant network circuit, a high/low voltage conversion circuit, and a signal processing circuit; the cavity of the receiving end is internally installed with a signal transmission circuit, a secondary resonant network circuit, a high/low voltage conversion circuit, a rectifier, and a charging circuit.

6. The wireless charging and signal transmission device for a deep-sea UUV docking system according to claim 1, wherein a port of the flexible guide cylinder is provided with a permanent magnet; and an outer wall of the integrated coil/antenna mount at the receiving end is provided with a flange, and the flange is provided with a stainless steel ring adapted to the permanent magnet.

7. The wireless charging and signal transmission device for a deep-sea UUV docking system according to claim 1, wherein an inner wall of one end of the flexible guide cylinder is of a cylindrical surface, the cylindrical surface has an annular boss, and the non-metallic sealing cover of the transmitting end contacts the annular boss; and the other end of the flexible guide cylinder is provided with a conical inclined surface for guiding the receiving end.

8. The wireless charging and signal transmission device for a deep-sea UUV docking system according to claim 1, wherein a manufacturing method of the integrated coil/antenna mount comprises:
(1) winding an Litz wire into a cylindrical coil, winding the coil until the inductance value thereof reaches half of a desired value, insulating the coil, and then placing the coil into the third groove;
(2) putting a plurality of magnetic cores into the second groove; after covering with the non-metallic sealing cover, adjusting a size of the magnetic core and the number of coil turns according to whether mutual inductance between the two coils of the transmitting end and the receiving end meets requirements, until the mutual inductance of the two coils meets the requirements;
(3) installing a watertight connector at the bottom of the integrated mount, and welding inner wires of the watertight connector to the coil wires;
(4) applying vacuumed silica gel liquid on a surface of the coil with a thickness of 0.5 mm to 1 mm; applying the vacuumed silica gel liquid on an outer surface of a ceramic antenna with a thickness of 0.5 mm to 1 mm;
(5) connecting a feeder of the ceramic antenna to the watertight connector; and after the silica gel liquid dries, installing and fixing the ceramic antenna into the first groove;
(6) pouring vacuumed epoxy resin liquid into the first groove, the second groove, and the third groove, so that the epoxy resin liquid is slightly higher than the top of the integrated mount; and
(7) after the epoxy resin is cured, turning a protruding part of the epoxy resin until being flush with a top of an encapsulation member, then covering it with the non-metallic sealing cover and fixing it with a radial screw.
